(19) United States
(12) Patent Application Publication
(10) Pub. No.: US 2020/0018399 A1
(43) Pub. Date: Jan. 16, 2020

(54) MECHANICAL SEAL WITH IMPROVED ANTI-ROTATION SYSTEM

(71) Applicant: MECCANOTECNICA UMBRA - S.P.A., Campello Sul Clitunno (PG) (IT)

(72) Inventors: Alessandro VENTURA, Terni (TR) (IT); Luigi Massimiliano FERRI, Campello Sul Clitunno (PG) (IT)

(21) Appl. No.: 16/458,962

(22) Filed: Jul. 1, 2019

(30) Foreign Application Priority Data
Jul. 11, 2018 (IT) 102018000007098

(51) Int. Cl. F16J 15/34; F16J 15/02

(52) U.S. Cl. CPC F16J 15/3452; F16J 15/025

(57) ABSTRACT

A mechanical seal includes: a fixed portion with a receptacle and a first seal ring provided on the receptacle, a rotary portion with a sleeve and a second seal ring provided on the sleeve, a cup mounted inside the receptacle with the possibility of sliding in an axial direction, a gasket housed in the cup, and a spring axially compressed between the receptacle and the cup. The spring has a first end constrained to the cup by means of first constraint means, and a second end constrained to the receptacle by means of second constraint means, in such a way that the spring opposes a rotation of the cup relative to the receptacle.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates to a mechanical seal, and particularly to a mechanical seal that is suitable for being disposed between a rotary shaft and an opening of a casing through which the shaft is mounted. The present invention finds a preferred, non-exclusive application in the seals of rotary pumps and in particular in pumps for the recirculation of refrigerant fluid in a motor of vehicle.

### 2. Description of Related Art Including Information Disclosed Under 37 CFR 1.97 and 37 CFR 1.98

As it is known, a mechanical seal comprises:
a fixed portion comprising a first seal ring,
a rotary portion comprising a second seal ring, and
a spring disposed in the fixed portion in such a way to push the first seal ring towards the second seal ring.

In view of the fact that, when rotating, the second seal ring slides on the first seal ring, the two seal rings tend to rotate relative to their housings in the fixed portion and in the mobile portion. Therefore, the mechanical seal must provide for an anti-rotation system to prevent the rotation of the seal rings in their housings. However, it must be considered that, while the second seal ring can be blocked in its housing of the rotary portion, the first seal ring must be free to translate axially when pushed by the spring.

WO2018/020460, in the name of the same applicant, discloses a mechanical seal provided with an anti-rotation system of the seal rings that provides for an elliptical coupling between the seal ring and the housing of the seal ring. In such a case, the first seal ring is free to translate axially when pushed by the spring, and it is locked in rotation by means of the elliptical coupling.

The fixed portion comprises a receptacle wherein a cup is slidingly mounted, holding the first seal ring by means of a gasket. The spring is disposed in the receptacle between a bottom wall of the receptacle and the cup. The ends of the spring are neither constrained to the bottom wall of the receptacle nor to the cup. In fact, the first seal ring is blocked in rotation and therefore does not transmit any rotation to the cup. Obviously, if the first seal ring was not blocked in rotation, the first seal ring would rotate and transmit said rotation to the cup, impairing the operation of the seal.

For the second seal ring, i.e. the rotary seal ring, this type of elliptical coupling works well, because the second seal ring must not translate axially. Instead, for the first seal ring, this type of elliptical coupling is impaired by some drawbacks because the first seal ring must translate axially. Moreover, said mechanical seal is difficult to assemble because of the larger dimension of the elliptical portion relative to the cylindrical portion where the gasket slides.

Mechanical seals are known, which comprise a bellows disposed behind the fixed seal ring to provide a seal that prevents the passage of the fluid. If the bellows is made of metal material, the bellows is welded and sealed to the structure of the mechanical seal. However, it must be considered that the bellows has a totally different structure compared to a helical spring and consequently a completely different torsional behavior compared to a helical spring. Therefore, the mechanical seals with bellows are not compatible with mechanical seals with spring because the spring does not have a seal function. In fact, in the mechanical seals with spring, the seal function is obtained with an elastomeric gasket.

In some applications of mechanical seals with a helical spring, the helical spring is blocked with a pin. However, such a blocking of the spring has proved to be unreliable.

It must be considered that in the field of mechanical seals, the springs are generally blocked with mechanical locks, such as pins. In fact, there is a technical prejudice against the use of a welding to block a spring because the welding is not considered reliable and it is considered to impair the correct operation of the spring.

### BRIEF SUMMARY OF THE INVENTION

The purpose of the present invention is to eliminate the drawbacks of the prior art by providing a mechanical seal with anti-rotation system of the seal rings that is effective, reliable and capable of delivering an excellent performance with a reduced volume.

Another purpose is to disclose a mechanical seal that is simple and inexpensive to make.

Said purposes are achieved by a mechanical seal according to claim 1.

Advantageous embodiments of the invention appear from the dependent claims.

The mechanical seal of the invention is defined by claim 1.

The peculiar characteristics are represented by the fact that the first seal ring is free to rotate relative to the receptacle. Moreover, the first end of the spring is constrained to the cup by means of the first constraint means, and the second end of the spring is constrained to the receptacle by means of the second constraint means. In view of the above, the spring opposes a rotation of the cup relative to the receptacle.

The applicant surprisingly discovered that the constraint means of the spring can be welding. In fact, after making several experimental tests on the operation of the mechanical seal, the applicant discovered that the welding of the spring are perfectly reliable and do not impair the operation of the spring.

### BRIEF DESCRIPTION OF THE SEVERAL VIEWS OF THE DRAWINGS

Additional features of the invention will appear manifest from the following detailed description, which refers to a merely illustrative, not limiting embodiment, as illustrated in the attached figures, wherein:

FIG. 1 an axial section of a mechanical seal according to the invention;

FIG. 2 is an enlarged view of a detail of FIG. 1, wherein the first and second constraint means of the spring consist in welding;

FIG. 2A is the same view as FIG. 2, except for it shows a variant of the constraint means;

FIG. 3 is an exploded perspective view of the parts of the rotary portion of the mechanical seal according to the invention; and

FIG. 4 is a cross-sectional view taken along the sectional plane IV-IV of FIG. 1, which shows an additional variant of the second constraint means that provide the coupling between one end of the spring and the receptacle.

### DETAILED DESCRIPTION OF THE INVENTION

With reference to the Figures, a mechanical seal is disclosed, which is generally indicated with reference numeral 100.

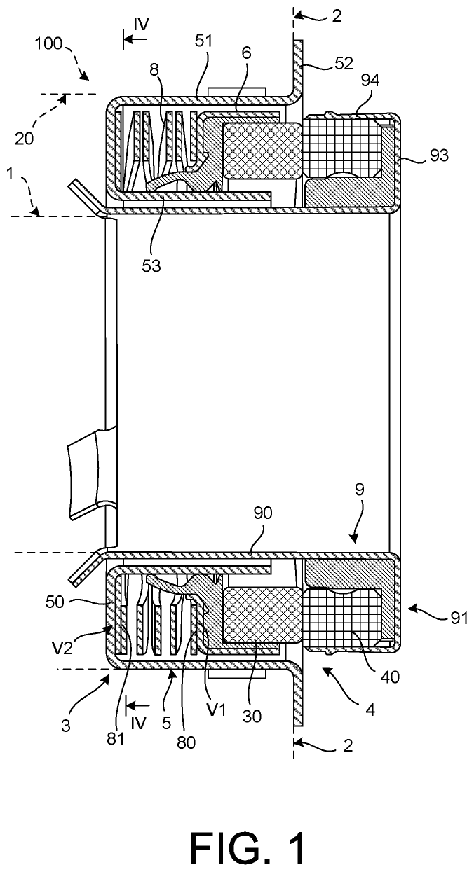

With reference to FIG. 1, the mechanical seal (100) is suitable for being disposed between a rotary shaft (1) and a fixed casing (2) provided with an opening (20) through which the rotary shaft (1) is mounted. For illustrative purposes, the shaft (1) and the casing (2) can be the shaft and the body of a recirculation pump of a cooling system of a motor vehicle (not shown).

The mechanical seal (1) comprises a fixed portion (3) constrained to the casing (2), and a rotary portion (4) integrally and revolvingly mounted to the shaft (1). The fixed portion (3) comprises a first seal ring (30). The rotary portion (4) comprises a second seal ring (40). The two seal rings (30, 40) cooperate axially and provide a sliding front seal.

Advantageously, the seal rings (30, 40) are of ceramic material, such as silicon carbide or carbon material.

The fixed portion (3) comprises an annular receptacle (5) made of sheet metal by means of spinning. The receptacle (5) comprises:
an annular flat bottom wall (50),
an external cylindrical wall (51) that extends from an external edge of the bottom wall (50) towards the seal rings (30, 40),
an external flange (52) that extends radially from an axial end of the external wall (51) in opposite position to the bottom wall (50), and
a tubular internal wall (53) that extends from an internal edge of the bottom wall (50) towards the seal rings (30, 40), coaxially to the external wall (51).

The external wall (51) of the receptacle is fixed and sealed inside the opening (20) of the casing (2). The flange (52) of the receptacle is axially stopped against the casing (1) and determines the axial position of the mechanical seal (100) relative to the casing (2).

The first seal ring (30) is mounted in a cup (6) that is housed in the receptacle (5) with possibility of sliding in axial direction. A gasket (7) of elastomeric material is disposed between the first seal ring (30) and the cup (6).

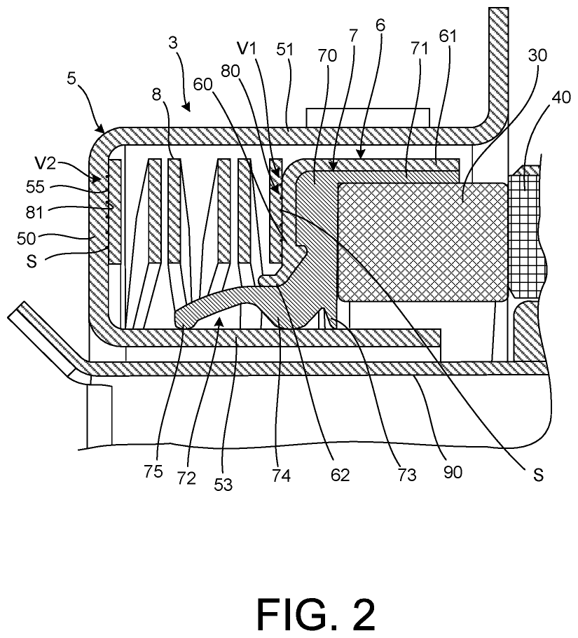

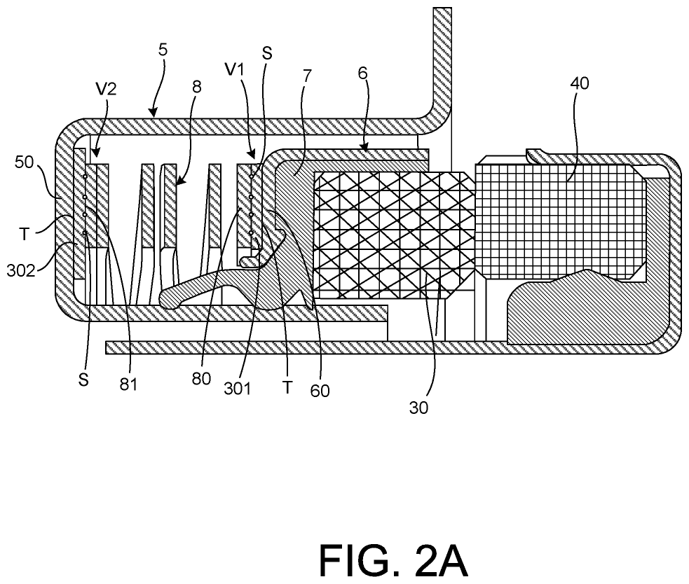

With reference to FIG. 2, the cup (6) comprises:
an annular flat bottom wall (60), which faces the bottom wall (50) of the receptacle, and
a cylindrical wall (61), which extends axially from an external edge of the bottom wall (60) in such a way to embrace said first seal ring (30), at least partially.

The bottom wall (60) of the cup has an internal edge (62) that is axially bent towards the bottom wall (50) of the receptacle and has an internal “J”-shaped rounded section.

The gasket (7) comprises:
an annular flat wall (70) axially disposed between the bottom ball (60) of the cup (6) and the first seal ring (30), and
an external cylindrical wall (71) axially projecting from the annular wall (70) and radially disposed between the cylindrical wall (61) of the cup and the first seal ring (30).

The seal ring (30) is axially blocked inside the cup (6) by means of radial interference, i.e. by radially compressing the cylindrical wall (61) of the gasket (7). The annular wall (70) of the gasket is axially compressed between the bottom ball (60) of the cup (6) and the first seal ring (30).

The gasket (7) is of bellows type and comprises a lip seal portion (72) that cooperates with an internal cylindrical wall (53) of the receptacle.

The lip seal portion (72) comprises:
a first lip (73) with annular blade that is radially internal to the annular wall (70) of the gasket,
a second intermediate lip (74) with convex rounded profile that is disposed inside the internal edge (62) of the cup, and
a third lip (75) that is radially flexible and extends axially towards the bottom wall (50) of the container.

The second lip (74) elastically cooperates with the internal wall (53) of the receptacle and provides a static seal between the cup (6) and the internal wall (53) of the receptacle. The first and the third lip (73; 75) cooperate with the second lip (74) of the gasket to provide a seal and are prevalently designed to protect the seal area against the penetration of dirt particles. Moreover, together with the second lip (72), the first and the third lip (73; 75) define corresponding annular chambers that can be optionally filled with a fuel.

The mechanical seal (100) also comprises a spring (8) that is housed in the receptacle (5) and is axially comprised between the bottom wall (50) of the receptacle and the bottom wall (60) of the cup, in such a way to axially push the first seal ring (30) against the second seal ring (40).

In the example, the spring (8) is a helical wave spring obtained with a flat ribbon, such as for example the springs sold under the name of Crest-to-Crest® by Smalley. However, the spring (8) can be replaced by an annular wave spring or by a conventional spring with a cylinder helix.

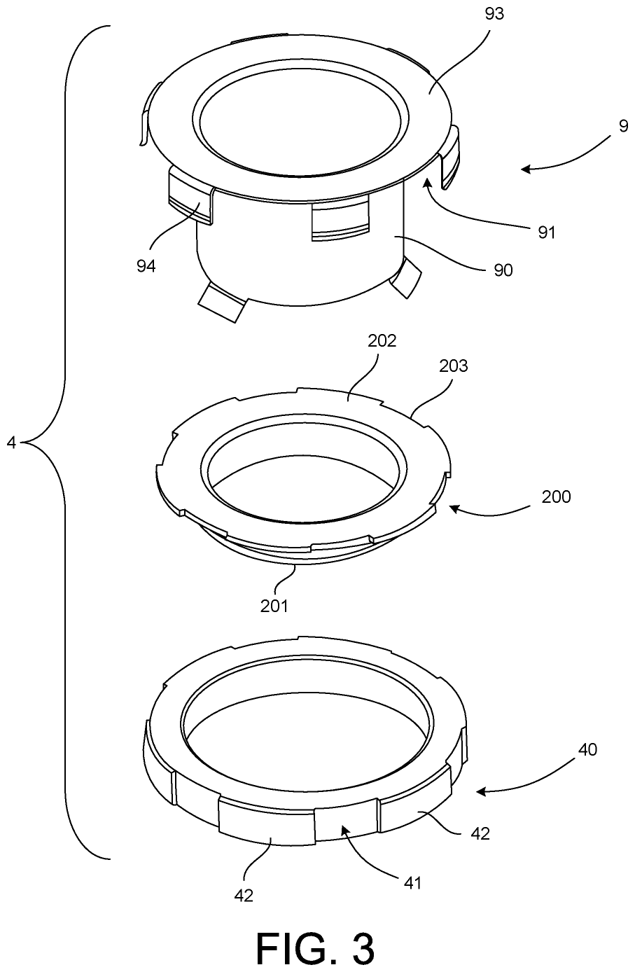

With reference to FIGS. 1 and 3, the rotary portion (4) of the mechanical seal (100) comprises a sleeve (9).

The sleeve (9) comprises:
a tubular portion (90) that is disposed through the receptacle (5) and is suitable for being fixed on the shaft (1), and
an annular housing portion (91) that is integral with the tubular portion (90) and houses the second seal ring (40).

The housing portion (91) of the sleeve comprises:
a flat radial end flange (93) that defines an axial stop for the second seal ring (40), and
a plurality of external tongues (94) that are axially bent by the flange (93) in such a way to embrace and block the second seal ring (40) in radial direction.

In view of the above, the tubular portion (90), the flange (93) and the external tongues (94) of the housing portion of the sleeve form a “U”-shaped housing where the second seal ring (40) is blocked.

Advantageously, the second seal ring (40) is blocked in the housing portion (91) of the sleeve by means of a cap (200) of elastomeric material disposed between the flange (93) of the sleeve and the second seal ring (40).

The cap (200) has a cylindrical body (201) with an annular flange (202) provided with openings that are obtained in the external edge of the annular flange. The openings (203) of the cap are suitable for receiving the external tongues (94) of the sleeve.

The second seal ring (40) has a plurality of recessed seats (41) that are obtained in an external edge. The recessed seats (41) are disposed between projections (42) shaped as an arched sector. The second seal ring (40) is compressedly coupled on the cylindrical body (201) of the cap, in such a way that the recessed seats (41) of the second seal ring are in register with the openings (203) of the cap. The external tongues (94) of the sleeve penetrate in the openings (203) of the cap and in the recessed seats (41) of the second seal ring, being disposed between the projections (42) of the second seal ring, in such a way to prevent the rotation of the second seal ring and of the cap relative to the sleeve.

Other anti-rotation systems, such as for example the elliptical coupling disclosed in WO2018/020460, can be provided between the second seal ring (40) and the sleeve (9).

The cap (200) can be omitted and the static seal between the second seal ring (40) and the sleeve (9) can be conveniently obtained by means of a FIP (formed in place) sealant disposed between the second seal ring (40) and the housing portion (91) of the sleeve.

With reference to FIG. 2, the spring (8) comprises:
a first end (80) constrained to the bottom wall (60) of the cup by means of first constraint means (V1), and
a second end (81) constrained to the bottom wall (50) or to the external lateral wall (51) of the receptacle by means of second constraint means (V2).

In view of the above, the spring (8) opposes a rotation of the cup (6) relative to the receptacle (5). Such a solution permits to leave the first seal ring (30) free to rotate relative to the receptacle (5). In fact, when the second seal ring (40) tends to transmit a rotation to the first seal ring (30), the first seal ring (30) tends to transmit a rotation to the cup (6); however, the cup (6) cannot rotated because the bottom wall (60) of the cup is constrained to the first end (80) of the spring, the spring (8) is subject to torsion and opposes the rotation of the cup (6).

Advantageously, the first constraint means (V1) can consist in welding (S), preferably spot welding, but also laser welding or condenser discharge welding.

Said first constraint means (V1) are easy to make because the first end (80) of the spring is constrained to the bottom wall (60) of the cup, outside the receptacle (5). Successively, the assembly formed of the first seal ring (30), the gasket (7), the cup (6) and the spring (8) is inserted in the receptacle (5).

The second constraint means (V2) can consist in welding (S) just like the first constraint means (V1).

With reference to FIG. 2, according to a first variant, the constraint means (V1, V2) can comprise two rings (301, 302) composed of washers or ring-shaped metal plates, which are welded to the ends (80, 81) of the spring (8) by means of welding (S), such as spot welding. The rings (301, 302) are respectively fixed to the bottom wall (60) of the cup and to the bottom wall (50) of the receptacle by means of fixing means (T) that can be welding or mechanical locks.

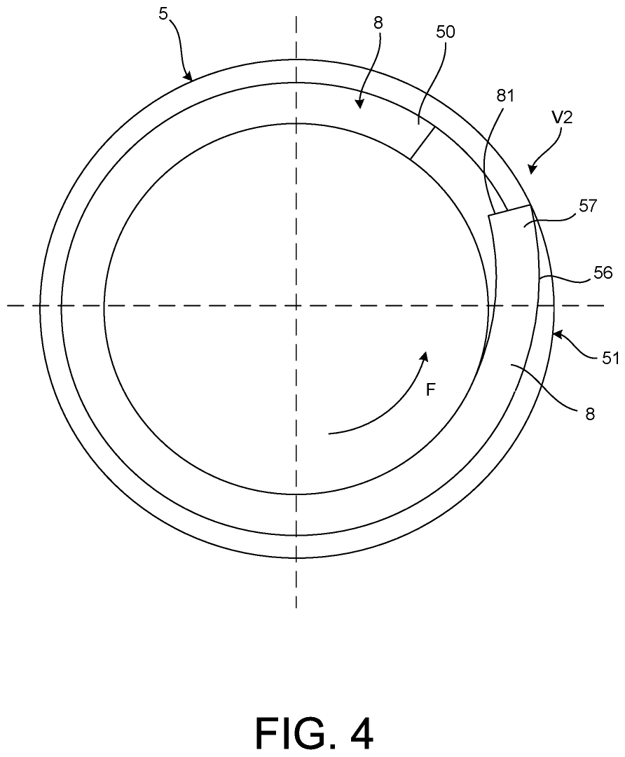

FIG. 4 shows an additional variant of the second constraint means (V2) that comprise a stop projection that is obtained in the bottom wall (50) of the receptacle and protrudes inwards. In view of the above, when the spring (8) tends to rotate in the direction of the arrow (F), the second end (81) of the spring is stopped against the stop projection of the bottom wall of the container, preventing a rotation of the spring relative to the receptacle.

With reference to FIG. 4, the second constraint means (V2) can provide for a guiding groove (56) that is obtained in the internal surface of the lateral external wall (51) of the receptacle, in such a way that the second end (81) of the spring slides in the guiding groove (56) to reach a stop (57) that generates a fit-in coupling of the second end (81) of the spring that blocks the rotation of the spring. Such a guiding groove (56) may be initially omitted in the lateral wall (51) of the receptacle and can be obtained by the second end (81) of the spring that is provided with a sharp corner that cuts the internal surface of the lateral external wall (51) of the receptacle. The provision of the guiding groove (56), which is created by the second end (81) of the spring, can avoid the provision of the stop projection on the bottom wall (50) of the receptacle.

This description continues by illustrating the operation of the mechanical seal (100).

During operation, the second seal ring (40) rotates integrally with the shaft (1). Therefore, a relative rotation with sliding is generated under the load of the spring (8) between the two seal rings (30, 40).

The rotational coupling of the second seal ring (40) is obtained by means of the cap (200) and the external tongues (94) of the sleeve that are engaged in openings (203) of the cap and in the recessed seats (42) of the second seal ring.

The rotational coupling of the first seal ring (30) is obtained by means of the spring (8) with the first end (80) constrained to the cup (6) and the second end (81) constrained to the receptacle (5).

The static seal between the gasket (7) and the receptacle (5) is obtained by means of the geometry of the lip seal portion (72) of the gasket, without the contribution of any rigid or elastic element to the compression of said portion against the internal wall (53) of the receptacle, except for the pressure of the fluid.

The function of the internal edge (62) of the cup is to contain the release of the lip seal portion (72) of the gasket in case of pressure on the inside, for example when a vacuum is generated before filling the cooling circuit.

Moreover, the function of the internal edge (62) of the cup is to prevent a possible adherence loss between the gasket (7) and the receptacle (5), with the consequent failure of the mechanical seal.

Such an adherence loss between gasket and receptacle can occur for many reasons, such as:
degradation of the elastomeric material of the gasket,
geometry and shape tolerances of the various elements,
surface finish of the components,
filling of the cooling circuit in vacuum condition.

The lip seal portion (72) of the gasket is free to slide in axial direction and rotate relative to the receptacle (5); this avoids self-induced vibrations caused by stick-slip phenomena between the seal rings (30, 40) and consequently noise. Moreover, the number of parts is reduced, thus increasing the simplicity, the cheapness and the reliability of the seal.

The lip seal portion (72) has a suitable geometry to prevent the penetration of dirt in the static seal area with the receptacle (5) and can also act as tank for a lubricant.

Being free to slide in axial direction, the gasket (7) does not generate an elastic load on the seal rings (30, 40) to obtain the dynamic seal. The consequent absence of elastic deformation contributes to reduce the radial volume and to entrust the load between the seal rings only to the spring (8), thus obtaining a higher stability of the load throughout the entire life of the mechanical seal (100).

Evidently, several variants can be made to the mechanical seal (100) without leaving the protection scope of the claims.

In particular, the fixed portion (3) of the mechanical seal can be directly installed in the external ring of the bearing of the shaft, which is suitably extended.

Moreover, the first seal ring (30) can be directly disposed in the cup (6), without the interposition of the wall (71) of the gasket.

We claim:

1. Mechanical seal suitable for being disposed between a rotary shaft and a fixed casing provided with an opening through which the rotary shaft is mounted, said mechanical seal comprising:
a fixed portion comprising a receptacle suitable for being mounted in said opening of the casing, and a first seal ring provided on said receptacle, and
a rotary portion comprising a sleeve suitable for being fixed on the rotary shaft and a second seal ring provided on the sleeve,
a cup mounted inside the receptacle with possibility of sliding in axial direction,
a gasket made of elastomeric material that is at least partially housed in the cup, in such a way to axially lock said first seal ring, and
a spring that is axially compressed between the receptacle and the cup, in such a way to push said first seal ring towards said second seal ring,
wherein said spring comprises:
a first end constrained to the cup with first constraint means, and
a second end constrained to the receptacle with second constraint means in such a way that said spring opposes a rotation of the cup with respect to the receptacle, and
wherein the first constraint means and/or the second constraint means consist in welding.

2. The mechanical seal of claim 1, wherein said welding of the first constraint means and/or the second constraint means is a spot welding.

3. The mechanical seal of claim 1, wherein said cup comprises:
an annular flat bottom wall, and
a cylindrical wall that extends axially from an external edge of the bottom wall in such a way to embrace said first seal ring, at least partially;
wherein said first end of the spring is constrained to said bottom wall of the cup by means of welding.

4. The mechanical seal of claim 2, wherein said receptacle comprises:
an annular flat bottom wall,
a lateral external cylindrical wall, and
a tubular internal wall that extends coaxially to the external wall in such a way to define an annular seat wherein the spring and the cup are disposed;
said second end of the spring being constrained to said bottom wall of the receptacle by means of welding.

5. The mechanical seal of claim 2, wherein said first constraint means and said second constraint means comprise two rings composed of washers or ring-shaped metal plates, where the ends of the spring are welded by means of welding; said rings being respectively fixed to a bottom wall of the cup and to a bottom wall of the receptacle by means of fixing means, such as welding or mechanical locks.

6. The mechanical seal of claim 1, wherein said seal comprises:
an annular flat wall that is axially disposed between a bottom wall of the cup and the first seal ring,
an external cylindrical wall that extends axially in projecting position from the annular wall and is radially disposed between a cylindrical wall of the cup and the first seal ring, and
a lip seal portion that cooperates with an internal cylindrical wall of the receptacle.

7. The mechanical seal of claim 6, wherein the bottom wall of the cup has an internal edge with an internal “J”-shaped rounded section that is axially bent towards the bottom wall of the receptacle in such a way to retain said lip seal portion of the seal.

8. The mechanical seal of claim 1, wherein said spring is a helical wave spring made with a flat ribbon.

9. Mechanical seal suitable for being disposed between a rotary shaft and a fixed casing provided with an opening through which the rotary shaft is mounted, said mechanical seal comprising:
a fixed portion comprising a receptacle suitable for being mounted in said opening of the casing, and a first seal ring provided on said receptacle, and
a rotary portion comprising a sleeve suitable for being fixed on the rotary shaft and a second seal ring provided on the sleeve,
a cup mounted inside the receptacle with possibility of sliding in axial direction,
a gasket made of elastomeric material that is at least partially housed in the cup, in such a way to axially lock said first seal ring, and
a spring that is axially compressed between the receptacle and the cup, in such a way to push said first seal ring towards said second seal ring,
wherein said spring comprises:
a first end constrained to the cup with first constraint means, and
a second end constrained to the receptacle with second constraint means in such a way that said spring opposes a rotation of the cup with respect to the receptacle, and
wherein the second constraint means comprise mechanical locks, such as joints or stops.

10. The mechanical seal of claim 9, wherein the second constraint means comprise a stop projection that is obtained in a bottom wall of the receptacle and projects inwards in such a way that the second end of the spring is stopped against the stop projection of the bottom wall of the receptacle.

11. The mechanical seal of claim 9, wherein the receptacle has a lateral external wall with a guiding groove that ends in a stop, in such a way that the second end of the spring slides in the guiding groove until it reaches the stop.
